(19) United States
(12) Patent Application Publication
(10) Pub. No.: US 2008/0147603 A1
(43) Pub. Date: Jun. 19, 2008

(54) CONVERTING TEMPORAL DATA INTO TIME SERIES DATA

(76) Inventors: Olli Pekka Kostamaa, Santa Monica, CA (US); Bhashyam Ramesh, Secunderabad (IN)

Correspondence Address: JAMES M. STOVER;TERADATA CORPORATION, 2835 MIAMI VILLAGE DRIVE, MIAMISBURG, OH, 45342, US

(21) Appl. No.: 11/610,534

(22) Filed: Dec. 14, 2006

(51) Int. Cl. G06F 7/06

(52) U.S. Cl. 707/3; 707/E17.014

(57) ABSTRACT

A method of and system for extracting time series data from temporal data in a database table is disclosed. The method comprises receiving a request for time series data, the request including information indicative of a period of time to be covered by the request, values sought by the request, time instants at which the values are sought and a precision between consecutive time instants, and creating a temporary table and populating the temporary table with a plurality of time stamps covering the period of time indicated by the request, consecutive time stamps being separated by the precision indicated by the request, and the time stamps specifying the time instants indicated by the request. The method also comprises querying the database table so as to identify for each time stamp in the temporary table, a row in the database table which has temporal data covering the time stamp and extracting values specified in the request from the identified rows, and associating the extracted data with the appropriate time stamps.

### FIELD OF THE INVENTION

The present invention relates to a system for and method of extracting time series data from temporal data in a relational database.

### BACKGROUND OF THE INVENTION

Relational database systems store data in tables organized by columns and rows. The tables are typically linked together by “relationships” that simplify the storage of data and make complex queries of the data more efficient. Structured Query Language (SQL) is a standardized language for creating and interacting with relational databases.

Relational databases are typically managed using a database management system (DBMS) which often comprises a suite of software programs to control organization, storage and retrieval of data in the database.

A relational database can store temporal information in a row of a table that includes a column of PERIOD data type. The PERIOD data type column defines a duration of time associated with the row, typically using a beginning time stamp and an end time stamp. The PERIOD data type is often indicative of the valid times of values in a row.

The PERIOD data type also includes an associated “granularity” value which specifies the minimum unit of time which is representable by the PERIOD data type. For example, the granularity may be a day, an hour, a minute, a second or a millisecond.

It is often desirable to extract time series information from a database wherein each value in the time series has an associated time stamp indicative of an instant in time at which the value is valid. The amount of time between consecutive values in the time series is referred to as the “precision” of the time series. The time series precision can be any suitable period of time such as a day, an hour, a minute, a second or a millisecond.

However, current methods of extracting time series information from a database with PERIOD data types are relatively inefficient and cumbersome.

### SUMMARY OF THE INVENTION

In accordance with a first aspect of the present invention, there is provided a method of extracting time series data from temporal data in a database table, said method comprising:

receiving a request for time series data, the request including information indicative of a period of time to be covered by the request, values sought by the request, time instants at which the values are sought and a precision between consecutive time instants;

creating a temporary table and populating the temporary table with a plurality of time stamps covering the period of time indicated by the request, consecutive time stamps being separated by the precision indicated by the request, and the time stamps specifying the time instants indicated by the request;

querying the database so as to identify for each time stamp in the temporary table a row from the database table which has temporal data covering the time stamp and extracting values specified in the request from the identified rows; and

associating the extracted data with the appropriate time stamps.

In one embodiment, steps carried out in relation to the database are implemented using SQL.

In one arrangement, the temporary table may be created using the following SQL statement:

CREATE TABLE TempDate
( MyDate TIMESTAMP(3))

The source of the temporal data may be created using the following SQL statement:

```
CREATE TABLE SourceTable
  ( Value <ValueDataType>,
  ValidTime PERIOD (TIMESTAMP(3)) );
```

The database is queried using the following SQL statement:

```
SELECT MyDate, Value
  FROM TempDate, SourceTable
  WHERE TempDate.MyDate >= SourceTable.ValidTime BEGIN
    AND TempDate.MyDate < SourceTable.ValidTime.END;
```

where TempDate is the created temporary table, SourceTable is the table from which values are sought by the request, MyDate is a field in the TempDate table which includes the time stamps specifying the time instants indicated by the request, Value is a field in the TargetTable table which includes values sought by the request,

SourceTable.ValidTime.BEGIN is the beginning time stamp of the Valid PERIOD in the SourceTable, and

SourceTable.ValidTime.END is the end time stamp of the Valid PERIOD in the SourceTable.

In one arrangement, the method further comprises allocating a granularity to the time stamps in the temporary table which is equal to the lower of the precision of the time stamps in the temporary table and the granularity of the temporal data.

In accordance with a second aspect of the present invention, there is provided a system for extracting time series data from temporal data in a database table,

the system being arranged to receive a request for time series data of the type including information indicative of a period of time to be covered by the request, values sought by the request, time instants at which the values are sought and a precision between consecutive time instants;

the system being arranged to create a temporary table and populate the temporary table with a plurality of time stamps covering the period of time indicated by the request, consecutive time stamps being separated by the precision indicated by the request, and the time stamps specifying the time instants indicated by the request; and

the system being arranged to query the database so as to identify for each time stamp in the temporary table, a row in the source table which has temporal data covering the time stamp and extracting values specified in the request from the identified rows, and to associate the extracted data with the appropriate time stamps.

In accordance with a third aspect of the present invention, there is provided a computer program arranged when loaded into a computer to instruct the computer to operate in accordance with a method of extracting time series data from temporal data in a database, said method comprising:

receiving a request for time series data, the request including information indicative of a period of time to be covered by the request, values sought by the request, time instants at which the values are sought and a precision between consecutive time instants;

creating a temporary table and populating the temporary table with a plurality of time stamps covering the period of time indicated by the request, consecutive time stamps being separated by the precision indicated by the request, and the time stamps specifying the time instants indicated by the request;

querying the database so as to identify for each time stamp in the temporary table, a row in the in the database table which has temporal data covering the time stamp and extracting values specified in the request from the identified rows; and

associating the extracted data with the appropriate time stamps.

### BRIEF DESCRIPTION OF THE DRAWINGS

The present invention will now be described, by way of example only, with reference to the accompanying drawings, in which:

FIG. 1 is a schematic block diagram of a database system usable to implement a system for and method of extracting time series data from temporal data in a relational database in accordance with an embodiment of the present invention; and

FIG. 2 is a flow diagram illustrating a method of extracting time series data from temporal data in a relational database in accordance with an embodiment of the present invention.

### DETAILED DESCRIPTION

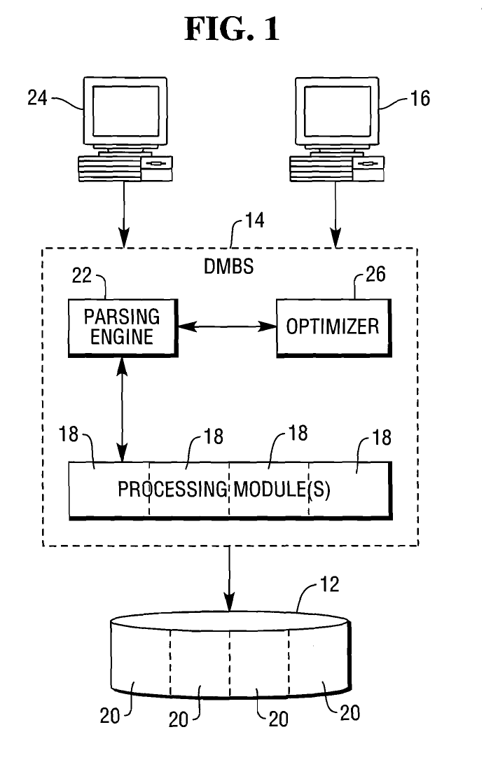

Referring to the drawings, FIG. 1 shows a database system 10 which comprises a database 12, and a database management system (DBMS) 14 for controlling organization, storage and retrieval of data in the database 12. The DBMS 14 is arranged to communicate with a database administrator 16 shown schematically in FIG. 1 as a computing device.

A typical DBMS 14 comprises one or more processing modules 18, each of which manages storage and retrieval of data in the database 12. In the present embodiment, the database 12 is distributed over multiple data storage devices 20, and a plurality of processing modules 18 are provided with each processing module 18 managing storage and retrieval of data in one data storage device 20. Each processing module 18 may comprise one or more physical processors or may comprise at least one virtual processor, with one or more virtual processors running on one or more physical processors.

The database system 10 stores data in one or more tables in the database 12 with rows of the database 12 preferably being stored across multiple data storage devices 20 to ensure that the system workload is distributed evenly across the processing modules 18.

The DBMS 14 also comprises a parsing engine 22 which organizes storage of data and distribution of table rows amongst the processing modules 18. The parsing engine 22 also coordinates retrieval of data from the data storage devices 20 in response to queries received from a user represented in FIG. 1 by a user computing device 24. The parsing engine 22 also accepts requests for authorisation to access the database 12, verifies the requests and either allows or disallows access depending on whether the requesting user is authorised and whether the request is authorised.

In this example, the DBMS 14 receives queries in SQL format. When a session has been allowed to begin, a user is able to submit a SQL request to the DBMS 14 which is routed to the parsing engine 22. The parsing engine 22 interprets the SQL request, checks it for proper SQL syntax, evaluates it semantically, and consults a data dictionary to ensure that each of the objects specified in the SQL request actually has the authority to perform the request. The parsing engine 22 also runs an optimizer 24 which determines the least expensive plan to perform the request.

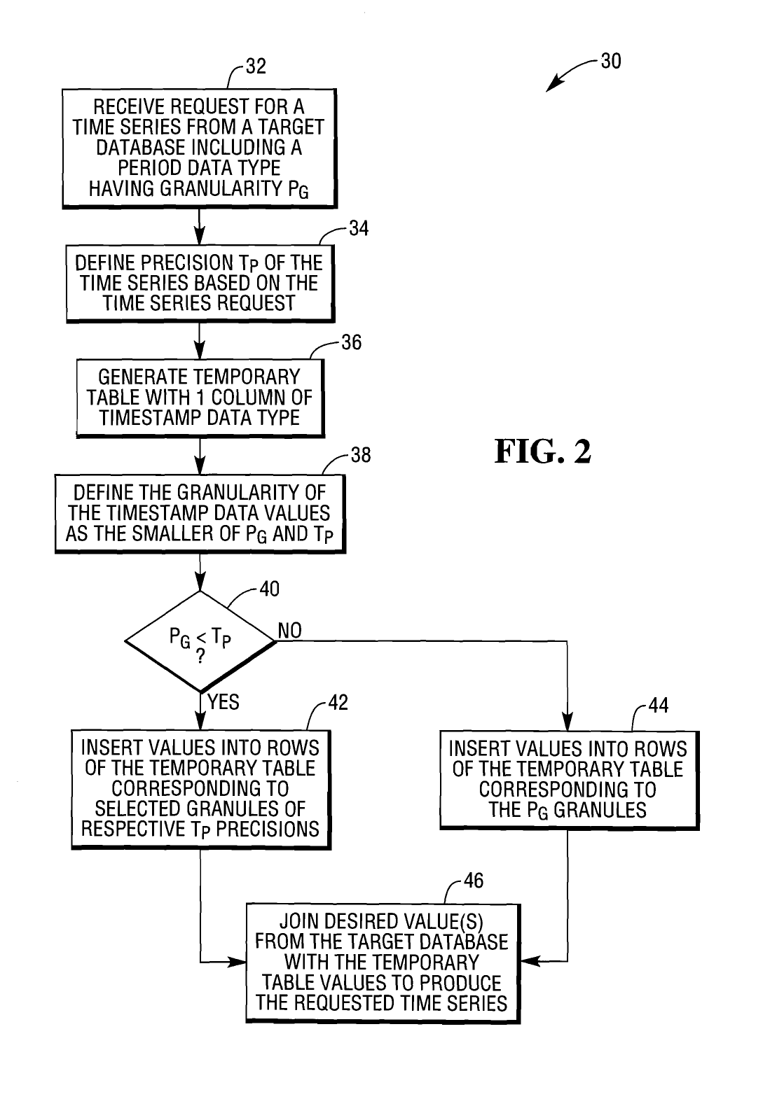

Referring to FIG. 2, there is shown a flow diagram 30 illustrating a method of extracting time series data from temporal data in a relational database in accordance with an embodiment of the present invention.

In this example, the method is implemented using the database system 10 and the database system is a SQL database system. Accordingly, method steps 32 to 46 of the flow diagram 30 refer to SQL specific actions. However, it will be understood that the invention is applicable to database systems other than SQL type databases systems.

The method enables time series data to be extracted from a database in an efficient manner compared to existing techniques.

As illustrated at step 32 in the flow diagram 30, a request is received from a user for a time series from a database table including a PERIOD data type having granularity P_{G}. After receiving the request, the DBMS 14 defines a precision T_{P} for the time series based on the desired time spacing between values in the time series specified in the request, as indicated at step 34. A temporary table having 1 column of TIMESTAMP data type is then created and the granularity of the values in the temporary table defined as the smaller of the PERIOD granularity P_{G} and the time series precision T_{P}, as shown at steps 36 and 38.

Rows are then inserted into the temporary table and the rows populated with time stamps such that the rows span the time period requested by the user and such that consecutive rows are separated from each other by the time precision T_{P} derived from the request.

If P_{G} is less than T_{P}, then for each period of time T_{P}, a selected granule of the T_{P} precision is inserted into the temporary table, the selected granule being determined based on the request. For example, if the request relates to opening or closing prices stored in a stock prices database, the selected granule may be the first granule of each period of time T_{P} or the last granule of each period of time T_{P} respectively. If P_{G} is greater than or equal to T_{P}, then the time data is inserted into the temporary table at P_{G} granularity. These steps are shown at 40, 42 and 44 of the flow diagram 30.

It will be understood that by extracting time information in this way, a temporary table including time stamp information indicative of instants in time spaced by the requested precision is produced, with each time stamp corresponding to a time instant at which a time series value is required based on the request.

When the temporary table has been populated with the time series information, a join query is executed which joins data in the database table corresponding to the initial request with the appropriate time stamps in the temporary table so as to produce the desired time series data. This is achieved by querying the database so as to identify for each time stamp in the temporary table, a row from the source table which has temporal data covering the time stamp, extracting desired data from the identified rows, and associating the extracted data with the appropriate time stamps.

An example illustrating a method of extracting time series rows from temporal data in a relational database will now be described. The example relates to a SQL type database, although it will be understood that other database types are envisaged.

A database defining a table of stock values is defined in SQL as:

```
CREATE TABLE TemporalT
  (StockNo INTEGER,
  Price DECIMAL (10,2),
  Valid PERIOD (TimeStamp(3)) );
```

where TemporalT is the name of the table, StockNo, Price and Valid are fields in the table and INTEGER, DECIMAL and PERIOD define the data types of the fields. The PERIOD data type has a beginning time stamp Valid.BEGIN and an end time stamp Valid.END. Timestamp(3) defines the granularity P_{G} of the PERIOD values, that is, the accuracy of the time stamps. In this example, the granularity P_{G} is a millisecond.

A query is received from a user as follws:

“Show me the daily closing price as of 4 pm of Stock number 51 between the dates of Jan. 1, 2005 and Mar. 31, 2005.”

The DBMS 14 creates a temporary table having one column with precision T_{P} defined as 1 day. A precision of 1 day is selected because the query specifies that the time series should include one value per day. The temporary table can be created in SQL as follws:

CREATE TABLE TempDate
(MyDate TIMESTAMP(3) );

where TempDate is the name of the table, MyDate is a field in the table and TIMESTAMP(3) defines the data type of the field.

The granularity of the values in the temporary table is defined as the smaller of T_{P} and P_{G}. In the present example, since the precision T_{P} defined by the user request is greater than the granularity P_{G} of the PERIOD values, the granularity of the temporary database is defined as P_{G}, that is, a millisecond.

Since the precision T_{P} defined by the user request is greater than the granularity P_{G} of the PERIOD values, values occurring at the last granule of each period of time corresponding to the precision T_{P} are inserted into the temporary table. In SQL this can be done as follows:

$$Row 1 \text{:} INSERT INTO TempDate ( “ 2005 \text{/} 01 \text{/} 01 \; 16 \text{:} 00 \text{:} 00.000 ” ) ; \\ Row 2 \text{:} INSERT INTO TempDate ( “ 2005 \text{/} 02 \text{/} 02 \; 16 \text{:} 00 \text{:} 00.000 ” ) ; \\ Row 3 \text{:} INSERT INTO TempDate ( “ 2005 \text{/} 01 \text{/} 03 \; 16 \text{:} 00 \text{:} 00.000 ” ) ; \\ ⋮ ⋮ ⋮ ⋮ ⋮ \\ Row 90 \text{:} INSERT INTO TempDate ( “ 2005 \text{/} 03 \text{/} 31 \; 16 \text{:} 00 \text{:} 00.000 ” ) ;$$

It will be appreciated that the period of time between consecutive time series rows (precision) is 1 day and the accuracy (granularity) is to one millisecond.

The DBMS 14 then issues a join query between the Stock table (TemporalT) and the temporary table (TempDate) to produce the requested time series data. This can be achieved in SQL as follows:

SELECT MyDate, Price
FROM TemporalT, TempDate
WHERE TempDate.MyDate >= TemporalT.Valid.BEGIN
AND TempDate.MyDate < TemporalT.Valid.END;

The join query identifies for each time stamp in the temporary database TempDate a row in the Stocks table TemporalT which has temporal data covering the time stamp, extracting the stock values from the identified rows in TemporalT, and associating the stock values with the appropriate time stamps.

Modifications and variations as would be apparent to a skilled addressee are deemed to be within the scope of the present invention.

1. A method of extracting time series data from temporal data in a database table, said method comprising:
receiving a request for time series data, the request including information indicative of a period of time to be covered by the request, values sought by the request, time instants at which the values are sought and a precision between consecutive time instants;
creating a temporary table and populating the temporary table with a plurality of time stamps covering the period of time indicated by the request, consecutive time stamps being separated by the precision indicated by the request, and the time stamps specifying the time instants indicated by the request;
querying the database table so as to identify for each time stamp in the temporary table a row from the database table which has temporal data covering the time stamp and extracting values specified in the request from the identified rows; and
associating the extracted data with the appropriate time stamps.

2. A method as claimed in claim 1, wherein steps carried out in relation to the database table are implemented using SQL.

3. A method as claimed in claim 2, wherein the database table is queried using the following SQL statement:
```
SELECT MyDate, Value
  FROM TempDate, SourceTable
  WHERE TempDate.MyDate >= SourceTableTime.Valid.BEGIN
    AND TempDate.MyDate < SourceTableTime.Valid.END;
```
where TempDate is the created temporary table, SourceTable is the table from which values are sought by the request,
MyDate is a field in the TempDate table which includes the time stamps specifying the time instants indicated by the request, and Value is a field in the TargetTable table which includes values sought by the request.

4. A method as claimed in claim 1, further comprising allocating a granularity to the time stamps in the temporary table which is equal to the lower of the precision of the time stamps in the temporary table and the granularity of the temporal data.

5. A method as claimed in claim 1, further comprising populating the temporary table with time stamps corresponding to selected granules of the precision of the time series derived from the request.

6. A method as claimed in claim 1, further comprising creating the temporary table using the following SQL statement:
CREATE TABLE TempDate
( MyDate TIMESTAMP(3)).

7. A method as claimed in claim 1, further comprising creating the database table using the following SQL statement:
```
CREATE TABLE SourceTable
  ( Value <ValueDataType>,
  ValidTime PERIOD (TIMESTAMP(3)) ).
```

8. A system for extracting time series data from temporal data in a database table,
the system being arranged to receive a request for time series data of the type including information indicative of a period of time to be covered by the request, values sought by the request, time instants at which the values are sought and a precision between consecutive time instants;
the system being arranged to create a temporary table and populate the temporary table with a plurality of time stamps covering the period of time indicated by the request, consecutive time stamps being separated by the precision indicated by the request, and the time stamps specifying the time instants indicated by the request; and
the system being arranged to query the database table so as to identify for each time stamp in the temporary table a row in the database table which has temporal data covering the time stamp and extracting values specified in the request from the identified rows, and to associate the extracted data with the appropriate time stamps.

9. A computer program arranged when loaded into a computer to instruct the computer to operate in accordance with a method of extracting time series data from temporal data in a database table, said method comprising:
receiving a request for time series data, the request including information indicative of a period of time to be covered by the request, values sought by the request, time instants at which the values are sought and a precision between consecutive time instants;
creating a temporary table and populating the temporary table with a plurality of time stamps covering the period of time indicated by the request, consecutive time stamps being separated by the precision indicated by the request, and the time stamps specifying the time instants indicated by the request;
querying the database table so as to identify for each time stamp in the temporary table a row in the database table which has temporal data covering the time stamp and extracting values specified in the request from the identified rows; and
associating the extracted data with the appropriate time stamps.
